(19) United States
(12) Patent Application Publication
(10) Pub. No.: US 2024/0314820 A1
(43) Pub. Date: Sep. 19, 2024

(54) METHOD AND APPARATUS FOR RESOURCE SELECTION AND EXCLUSION IN SIDELINK FULL DUPLEX IN A WIRELESS COMMUNICATION SYSTEM

(71) Applicant: ASUS Technology Licensing Inc., Taipei City (TW)

(72) Inventor: Ming-Che Li, Taipei City (TW)

(21) Appl. No.: 18/607,220

(22) Filed: Mar. 15, 2024

Related U.S. Application Data
(60) Provisional application No. 63/452,469, filed on Mar. 16, 2023.

(51) Int. Cl. H04W 72/40; H04W 72/0446; H04W 72/0453; H04W 72/541

(52) U.S. Cl. CPC H04W 72/40; H04W 72/0446; H04W 72/0453; H04W 72/541

(57) ABSTRACT

Systems, apparatuses, and methods are provided for sidelink positioning reference signal and sidelink control information in a wireless communication system, comprising having or obtaining configuration of a set of sidelink resource pools within one Bandwidth Part (BWP) for sidelink or one carrier or cell for sidelink, not performing monitoring or not performing sensing within a first frequency region in a first slot or occasion, performing monitoring or sensing in a second frequency region in the first slot or occasion, triggering or requesting sensing-based resource (re-)selection, in a second slot or occasion, determining a first set of slots or occasions based on the first slot or occasion and a set of periodicities, excluding (all) candidate sidelink resources within the first frequency region in the first set of slots or occasions, and keeping candidate sidelink resources within the second frequency region in the first set of slots or occasions, in response to the non-monitoring or non-sensing in the first frequency region in the first slot or occasion.

### CROSS-REFERENCE TO RELATED APPLICATIONS

The present Application claims priority to and the benefit of U.S. Provisional Patent Application Ser. No. 63/452,469, filed Mar. 16, 2023, which is fully incorporated herein by reference.

### FIELD

This disclosure generally relates to wireless communication networks and, more particularly, to a method and apparatus for sidelink positioning reference signal and sidelink control information in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for sidelink positioning reference signal and sidelink control information in a wireless communication system. In various embodiments, for sidelink full duplex, sensing-based resource (re-)selection of the present invention can be applied with higher resource utilization efficiency and avoid unnecessary resource exclusion.

In various embodiments, systems and apparatuses are provided for a method of a first device in a wireless communication system comprising having or obtaining configuration of a set of sidelink resource pools within one Bandwidth Part (BWP) for sidelink or one carrier or cell for sidelink, wherein the set of sidelink resource pools comprise a first sidelink resource pool and/or a second sidelink resource pool, not performing monitoring or not performing sensing within a first frequency region in a first slot or occasion, performing monitoring or sensing in a second frequency region in the first slot or occasion, wherein the first frequency region and the second frequency region are within the first sidelink resource pool, triggering or requesting sensing-based resource (re-)selection, in a second slot or occasion, for determining sidelink resources in the first sidelink resource pool, determining a first set of slots or occasions based on the first slot or occasion and a set of periodicities, wherein the first slot or occasion is within a sensing window or duration associated with the sensing-based resource (re-)selection, excluding (all) candidate sidelink resources within the first frequency region in the first set of slots or occasions, in response to non-monitoring or non-sensing in the first frequency region in the first slot or occasion, and keeping candidate sidelink resources within the second frequency region in the first set of slots or occasions, in response to the non-monitoring or non-sensing in the first frequency region in the first slot or occasion.

In various embodiments, systems and apparatuses are provided for a method of a first device in a wireless communication system comprising having or obtaining configuration of a set of sidelink resource pools within one BWP for sidelink or in one carrier or cell for sidelink, wherein the set of sidelink resource pools comprise a first sidelink resource pool and/or a second sidelink resource pool, not performing monitoring or not performing sensing within a first frequency region in a first slot or occasion, performing monitoring or sensing in a second frequency region in the first slot or occasion, wherein the first frequency region and the second frequency region are within the first sidelink resource pool, triggering or requesting sensing-based resource (re-)selection, in a second slot or occasion, for determining sidelink resources in the first sidelink resource pool, determining a first set of slots or occasions based on the first slot or occasion and a set of periodicities, wherein the first slot or occasion is within a sensing window or duration associated with the sensing-based resource (re-)selection, and excluding (all) candidate sidelink resources within the first sidelink resource pool in the first set of slots or occasions, in response to the non-monitoring or non-sensing in the first frequency region in the first slot or occasion.

In various embodiments, systems and apparatuses are provided for a method of a first device in a wireless communication system comprising having or obtaining configuration of a set of sidelink resource pools within one BWP for sidelink or in one carrier or cell for sidelink, wherein the set of sidelink resource pools comprise a first sidelink resource pool and/or a second sidelink resource pool, performing a first sidelink transmission in the first sidelink resource pool in a first slot or occasion, performing sidelink reception or monitoring in the second sidelink resource pool in the first slot or occasion, triggering or requesting sensing-based resource (re-)selection, in a second slot or occasion, for determining sidelink resources in the first sidelink resource pool, determining a first set of slots or occasions based on the first slot or occasion and a set of periodicities, wherein the first slot or occasion is within a sensing window or duration associated with the sensing-based resource (re-)selection, and excluding (all) candidate sidelink resources within the first sidelink resource pool in the first set of slots or occasions, in response to non-monitoring or non-sensing in the first sidelink resource pool in the first slot or occasion.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is an example diagram showing that an associated PSCCH scheduling corresponding PSSCH resources, and associated PSFCH resource(s) can be derived at least based on the starting sub-channel or full sub-channel(s) of the PSSCH and sidelink slot of the PSCCH/PSSCH resource in accordance with embodiments of the present invention.

FIG. 6 is an example diagram showing that when sensing-based resource selection is triggered/requested in slot n, the UE will have a candidate resource set comprising multiple candidate resources, in accordance with embodiments of the present invention.

FIG. 7 is an example diagram showing that, in the first slot, the UE may determine to perform the first PSSCH transmission in the first PSSCH resource in the first sidelink resource pool, in accordance with embodiments of the present invention.

FIG. 8 is a flow diagram of method of a first device in a wireless communication system comprising dividing/partitioning frequency resources of a first sidelink resource pool into at least a first subset of frequency resources and a second subset of frequency resources in frequency domain, performing the determined first sidelink transmission in the first subset of frequency resources in the first slot/occasion, and performing sidelink reception/monitoring in the second subset of frequency resources in the first slot/occasion, in accordance with embodiments of the present invention.

FIG. 9 is a flow diagram of a method of a first device in a wireless communication system comprising having configuration of a set of sidelink resource pools within one sidelink BWP or in one sidelink carrier/cell, restricting/allowing to perform either sidelink transmission or sidelink reception/monitoring in one sidelink resource pool at a timing, performing a first sidelink transmission in the first sidelink resource pool in a first slot/occasion, and performing sidelink reception/monitoring in the second sidelink resource pool in the first slot/occasion, in accordance with embodiments of the present invention.

FIG. 10 is a flow diagram of a method of a first device in a wireless communication system comprising having configuration of a set of sidelink resource pools within one sidelink BWP or in one sidelink carrier/cell, not performing monitoring/sensing within a first frequency region in a first slot/occasion, performing monitoring/sensing in a second frequency region in the first slot/occasion, triggering/requesting sensing-based resource (re-)selection in a second slot/occasion, determining a first set of slots/occasions based on the first slot/occasion and a set of periodicities, excluding candidate sidelink resources within the first frequency region in the first set of slots/occasions, and excluding/preventing from excluding candidate sidelink resources within the second frequency region in the first set of slots/occasions, in accordance with embodiments of the present invention.

FIG. 11 is a flow diagram of a method of a first device in a wireless communication system comprising having or obtaining configuration of a set of sidelink resource pools within one sidelink BWP or one sidelink carrier or cell, not performing monitoring or sensing within a first frequency region in a first slot or occasion, performing monitoring or sensing in a second frequency region in the first slot or occasion, triggering or requesting sensing-based resource (re-)selection, in a second slot or occasion, determining a first set of slots or occasions based on the first slot or occasion and a set of periodicities, excluding (all) candidate sidelink resources within the first frequency region in the first set of slots or occasions, and keeping candidate sidelink resources within the second frequency region in the first set of slots or occasions, in accordance with embodiments of the present invention.

FIG. 12 is a flow diagram of a method of a first device in a wireless communication system comprising having or obtaining configuration of a set of sidelink resource pools within one sidelink BWP or in one sidelink carrier or cell, not performing monitoring or sensing within a first frequency region in a first slot or occasion, performing monitoring or sensing in a second frequency region in the first slot or occasion, triggering or requesting sensing-based resource (re-)selection, in a second slot or occasion, determining a first set of slots or occasions based on the first slot or occasion and a set of periodicities, and excluding (all) candidate sidelink resources within the first sidelink resource pool in the first set of slots or occasions, in accordance with embodiments of the present invention.

FIG. 13 is a flow diagram of a method of a first device in a wireless communication system comprising having or obtaining configuration of a set of sidelink resource pools within one sidelink BWP or in one sidelink carrier or cell, performing a first sidelink transmission in the first sidelink resource pool in a first slot or occasion, performing sidelink reception or monitoring in the second sidelink resource pool in the first slot or occasion, triggering or requesting sensing-based resource (re-)selection, in a second slot or occasion, determining a first set of slots or occasions based on the first slot or occasion and a set of periodicities, and excluding (all) candidate sidelink resources within the first sidelink resource pool in the first set of slots or occasions, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.213 V17.2.0 (2022-06) 3GPP; TSG RAN; NR; Physical layer procedures for control (Release 17); [2] 3GPP TS 38.214 V17.1.0 (2022-03) 3GPP; TSG RAN; NR; Physical layer procedures for data (Release 17); [3] 3GPP TS 38.212 V17.1.0 (2022-03) 3GPP; TSG RAN; NR; Multiplexing and channel coding (Release 17); [4] RP-220633, “Revised SID: Study on evolution of NR duplex operation”; [5] RANI Chair's Notes of 3GPP TSG RAN WG1 #109-e; [6] RANI Chair's Notes of 3GPP TSG RAN WG1 #110; [7] RANI Chair's Notes of 3GPP TSG RAN WG1 #110bis; [8] RAN1 Chair's Notes of 3GPP TSG RAN WG1 #111; and [9] PCT International Publication WO2022/211895A1, internationally filed Jan. 28, 2022 and titled “SIDELINK FEEDBACK FOR FULL DUPLEX USER EQUIPMENT”. The standards and documents listed above are hereby expressly and fully incorporated herein by reference in their entirety.

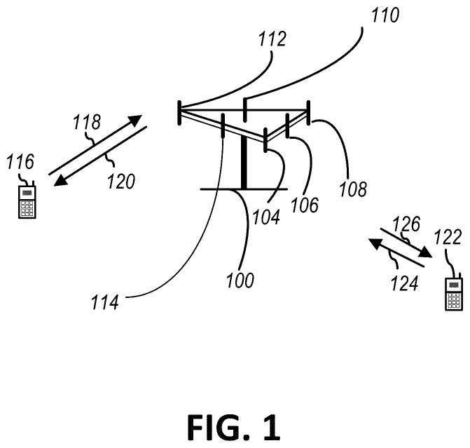

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

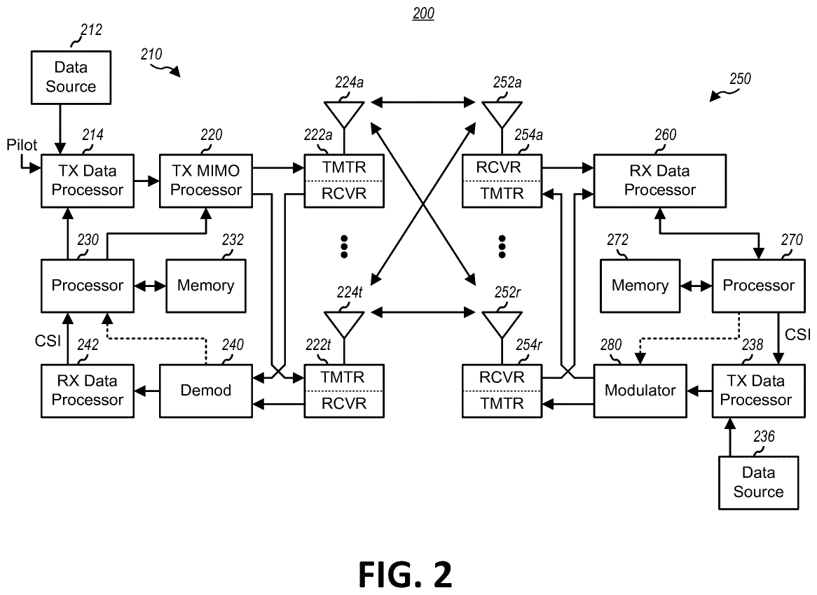

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T}modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

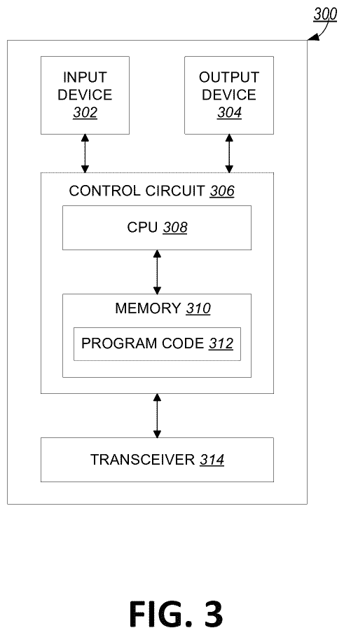

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

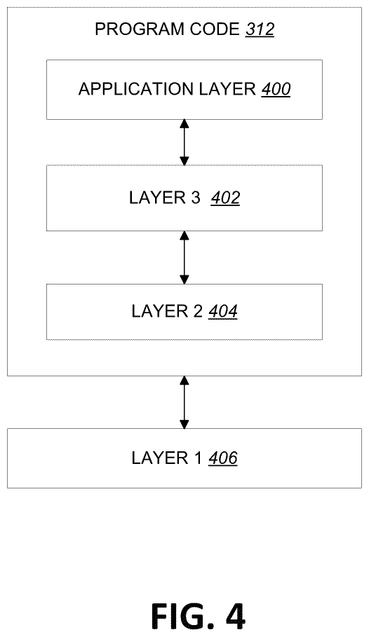

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In TS 38.213 (e.g., . . . [1] 3GPP TS 38.213 V17.2.0 (2022-06) 3GPP; TSG RAN; NR; Physical layer procedures for control (Release 17)). SL related procedure for control is specified.

For New Radio (NR) Release-16/17 sidelink (User Equipment (UE)-to-UE or device-to-device), sidelink slots can be utilized for Physical Sidelink Broadcast Channel (PSBCH) or Physical Sidelink Control Channel (PSCCH)/Physical Sidelink Shared Channel (PSSCH)/Physical Sidelink Feedback Channel (PSFCH) transmission/reception. PSBCH is Time Division Multiplexed (TDMed), in slot level, from PSCCH/PSSCH/PSFCH. It means that sidelink slots except slots for PSBCH can be utilized for PSCCH/PSSCH/PSFCH transmission/reception. Moreover, the concept of sidelink resource pool for sidelink communication is utilized for PSCCH/PSSCH and/or/PSFCH transmission/reception. A sidelink (communication) resource pool will comprise a set of sidelink slots (except slots for PSBCH) and a set of frequency resources. Different sidelink (communication) resource pools may be TDMed and/or Frequency Division Multiplexed (FDMed). More specifically, a PSCCH in one sidelink (communication) resource pool can only schedule PSSCH resource(s) in the same one sidelink (communication) resource pool. A PSCCH in one sidelink (communication) resource pool is not able to schedule PSSCH resource(s) in other/another sidelink (communication) resource pool. For a PSCCH/PSSCH, associated PSFCH is in the same sidelink (communication) resource pool, instead of in different sidelink (communication) resource pools.

For NR Rel-16 sidelink, PSFCH is designed/utilized for transmitting sidelink Hybrid Automatic Repeat Request (HARQ)-Acknowledgement (ACK) feedback. For a sidelink resource pool, PSFCH resources are (pre-)configured periodically with a period of N sidelink slots associated with the sidelink resource pool. Accordingly, PSCCH/PSSCH transmissions in N consecutive sidelink slots may be associated with PSFCH resources in a same slot. For a PSCCH/PSSCH transmission, at least a number of PSFCH resources (in the same PSFCH occasion) can be derived based on the starting sub-channel or full sub-channel(s) of the associated PSSCH transmission and the sidelink slot of associated PSCCH/PSSCH transmission. A receiver UE receiving the PSCCH/PSSCH transmission may derive/determine a PSFCH resource, from the number of PSFCH resources, for transmitting sidelink HARQ-ACK feedback associated with the PSCCH/PSSCH transmission.

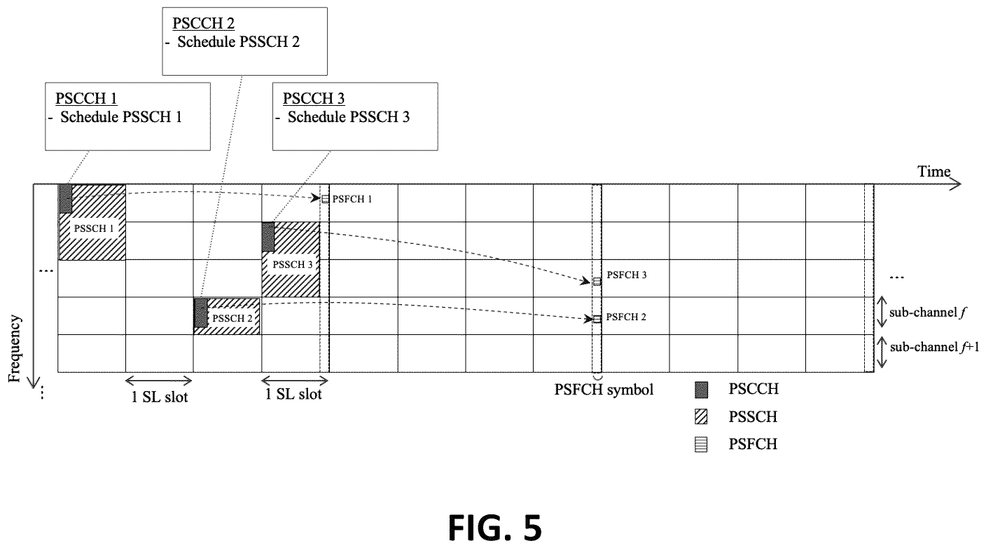

As an instance shown in FIG. 5, there are 3 PSSCH transmissions in one sidelink resource pool, i.e., PSSCH 1˜3. For each PSSCH, associated PSCCH schedules corresponding PSSCH resource, and associated PSFCH resource(s) can be derived at least based on the starting sub-channel or full sub-channel(s) of the PSSCH and sidelink slot of the PSCCH/PSSCH resource. For instance, PSCCH 1 schedules the resource of PSSCH 1, and the resource of PSFCH 1 is associated with the resource of PSSCH1 and/or PSCCH 1, and so on. Now, assuming the PSSCH 1 is transmitted from a transmitting device for delivering a data packet. A receiving device may receive the PSSCH 1 for acquiring the data packet from the transmitting device. Moreover, the PSSCH 1 may be indicated as sidelink HARQ-ACK enabled. The receiving device may transmit sidelink HARQ-ACK feedback, via the PSFCH 1, to the transmitting device to indicate whether the data packet is decoded successfully or not. The transmitting device may perform sidelink retransmission for delivering the same data packet if detecting/receiving HARQ-ACK feedback as Negative Acknowledgement (NACK) or Discontinuous Transmission (DTX). The transmitting device may not perform sidelink retransmission for delivering the same data packet if detecting/receiving HARQ-ACK feedback as ACK.

Note that a UE is capable to perform at most one PSSCH transmission in one sidelink slot. While the UE is capable to perform Nₘₐₓ PSFCH transmissions simultaneously in one PSFCH occasion, wherein Nₘₐₓ is 4, 8, 16 depending on UE transmission capability. When the UE performs PSCCH/PSSCH transmission in a sidelink slot, the UE is not capable to receive PSCCH/PSSCH in the same sidelink slot, and vice versa. When the UE performs one or more PSFCH transmission(s) in a PSFCH occasion, the UE is not capable to receive PSFCH in the same PSFCH occasion, and vice versa. This is because NR Release-16/17, and even Release-18, sidelink only supports half-duplex operation.

One sidelink (communication) resource pool will comprise multiple sub-channels in frequency domain, wherein a sub-channel comprises multiple contiguous Physical Resource Blocks (PRBs) in frequency domain. One PRB comprises multiple Resource Elements (REs), e.g., one PRB consists of 12 REs. Configuration of the sidelink resource pool will indicate the number of PRBs of each sub-channel in the corresponding sidelink resource pool. Sub-channel based resource allocation in frequency domain is supported for PSSCH. For a PSSCH resource scheduled by a PSCCH in the same sidelink slot, a fixed relationship between the PSCCH and the PSSCH resource is specified, which means that the PSCCH will be located in the lowest (index of) sub-channel of the scheduled PSSCH resource. As for scheduled PSSCH resource in different slot(s), the starting frequency position of the scheduled PSSCH resource will be scheduled/indicated by sidelink control information, instead of a fixed relationship.

In current NR Release-16/17 sidelink, one Sidelink Control Information (SCI) could indicate at most three PSSCH resources via Frequency resource assignment and/or Time resource assignment in the SCI. The SCI may comprise a 1st stage SCI and a 2nd stage SCI. The 1st stage SCI may be transmitted via PSCCH. The 2nd stage SCI may be transmitted via multiplexed with the scheduled PSSCH resource in the same sidelink slot, e.g., the first PSSCH resource. In other words, the SCI can schedule at most two PSSCH resources in later sidelink slots, e.g., the second PSSCH resource and/or the third PSSCH resource. The at most three PSSCH resources are in different slots in a sidelink (communication) resource pool. The at most three PSSCH resources are within 32 consecutive slots in a sidelink resource pool. The at most three PSSCH resources are utilized/associated with a same data packet, e.g., a same Transport Block (TB) or a same Medium Access Control (MAC) Packet Data Unit (PDU).

Moreover, resource reservation for another TB by a SCI could be (pre-)configured with enabled or not enabled or not configured in a sidelink (communication) resource pool. When a sidelink (communication) resource pool is configured with enabled such resource reservation, the sidelink (communication) resource pool is configured with a set of reservation period values. Possible reservation period could be 0, 1:99, 100, 200, 300, 400, 500, 600, 700, 800, 900, 1000 ms. Resource reservation period field in a SCI in the sidelink (communication) resource pool could indicate which reservation period value for (future) resource reservation. The size/number of the set of reservation period values could be from 1 to 16.

In NR Release-16/17 sidelink, there are two sidelink resource allocation modes defined for NR sidelink communication:
mode 1 is that the base station/network node can schedule sidelink resource(s) to be used by the UE for sidelink transmission(s); or
mode 2 is that the UE determines (i.e., base station/network node does not schedule) sidelink transmission resource(s) within sidelink resources configured by the base station/network node or pre-configured sidelink resources.

For network scheduling mode, e.g., NR sidelink resource allocation mode 1, the network node (e.g., gNB) may transmit a Sidelink (SL) grant, e.g., Downlink Control Information (DCI) format 3_0, on Uu interface for scheduling at most three PSSCH resources (for a same data packet). The sidelink grant also comprises “resource pool index” for indicating one sidelink (communication) resource pool, wherein the scheduled at most three PSSCH resources are within the indicated one sidelink (communication) resource pool. The transmission (TX) UE may perform PSCCH and PSSCH transmissions on PC5 interface, in response to the received sidelink grant, for a data packet. The Uu interface means the wireless interface for communication between network node and UE/device. The PC5 interface means the wireless interface for communication (directly) between UEs/devices.

For UE (autonomous) selection mode, e.g., NR sidelink resource allocation mode 2, since transmission resource is not scheduled via a network node, the UE may require performing sensing before selecting a resource for transmission (e.g., sensing-based transmission), in order to avoid resource collision and interference from or to other UEs (especially UEs using LTE/NR sidelink). Full sensing is supported in NR Rel-16 sidelink, while partial sensing is supported in NR Rel-17 sidelink. Based on result of sensing procedure, the UE can determine a valid/identified resource set. The valid/identified resource set may be reported to higher layers (of the UE). The UE may (randomly) select one or multiple valid/identified resources from the valid/identified resource set to perform sidelink transmission(s) from the UE. The sidelink transmission(s) from the UE may be PSCCH and/or PSSCH transmission.

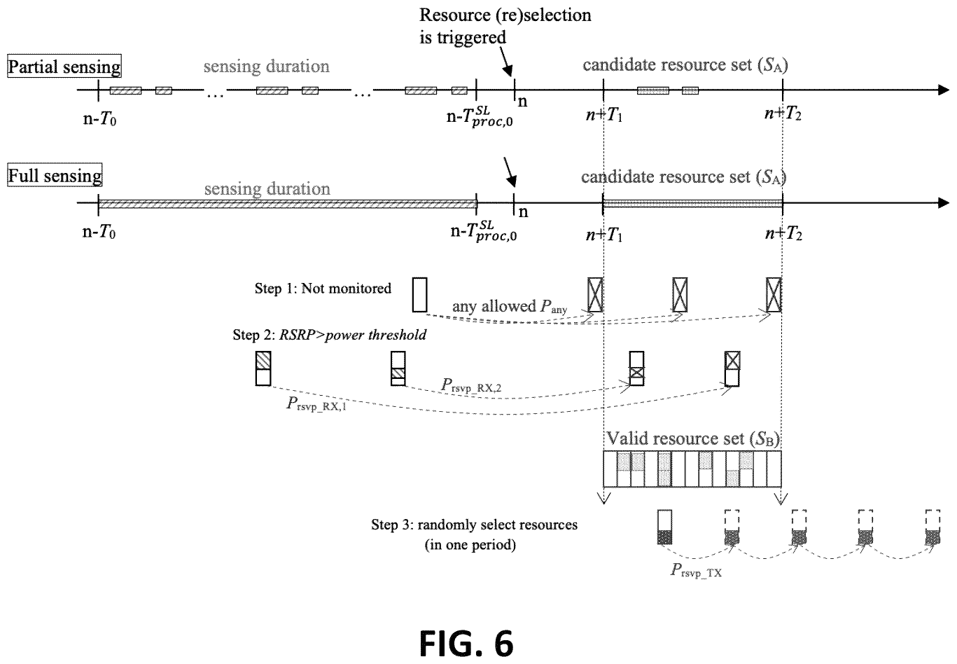

As an instance shown in FIG. 6, when sensing-based resource selection is triggered/requested in slot n, the UE will have a candidate resource set comprising multiple candidate resources. The available candidate resource set is restricted with time interval [n+T₁,n+T₂], which may be called as resource selection window.

If full sensing is performed (e.g., [2] 3GPP TS 38.214 V17.1.0 (2022-03) 3GPP), e.g., partial sensing is not configured, the available candidate resource sets are in the (full) time interval [n+T₁,n+T₂]. The UE shall monitor/sense slots within a sensing window [n−T₀, n−T_{proc,0}^{SL}). Preferably in certain embodiments, a candidate resource may mean one candidate single-slot resource. One candidate resource may comprise one or multiple resource units within one slot, wherein the resource unit may be a sub-channel.

When partial sensing is performed/configured (e.g., [2] 3GPP TS 38.214 V17.1.0 (2022-03) 3GPP), the UE determines by its implementation a set of candidate slots which consists of at least Y candidate slots within the time interval [n+T₁,n+T₂], wherein the available candidate resource set are in the set of candidate slots. For periodic-based partial sensing, if a slot t_{y} is in the set of candidate slots, the UE shall monitor/sense any slot t_{y}−(k×P′reserve) within sensing window. For contiguous partial sensing, the UE shall monitor/sense slots [n+T_{A}, n+T_{B}] within a sensing window, wherein T_{A} and T_{B} are both selected such that the UE has sensing results starting at least M consecutive logical slots before first slot of the selected Y candidate slots.

Based on sensing result, the UE may generate a valid/identified resource set, wherein the valid/identified resource set is a subset of the candidate resource set. The generation of the valid/identified resource set may be performed via excluding some candidate resources from the candidate resource set, for instance the step 1 and step 2 shown in FIG. 5. If remaining candidate resources after exclusion steps is smaller than X (e.g., 20%) the available candidate resource set, the UE may re-perform an exclusion step via increasing power threshold by 3 dB. After that, the UE can determine the valid/identified resource set. The resource selection for sidelink transmission may be randomly selected from the valid/identified resource set, for instance the step 3 shown in FIG. 6.

As specified in [2] 3GPP TS 38.214 V17.1.0 (2022-03) 3GPP, the first excluding step is that if the UE does not monitor/sense a Transmission Time Interval z (TTI z), the UE cannot expect whether the candidate resources in TTI “z+P_{any}” are occupied or not, wherein P_{any} means any possible periodicity configured in the sidelink (communication) resource pool. For instance, the first excluding step is shown as the step 1 in FIG. 6. The UE excludes the candidate resources in TTI “z+q P_{any}” and excludes the candidate resources for which other UE(s) may have possible transmission occurring in TTI “z+q·P_{any}”, wherein q is 1 or 1, 2, . . . , ┌T_{scal}/P_{rsvp_RX}┐. The parameter q means that the UE excludes multiple candidate resources with period P_{rsvp_RX} within time interval [z, z+T_{scal}].

The second excluding step is that if the UE receives/detects a sidelink control signaling (e.g., SCI format 1) in a TTI m, the UE may exclude the candidate resources according to the received sidelink control signaling. For instance, the second excluding step is shown as the step 2 in FIG. 6. More specifically, if the UE receives/detects a sidelink control signaling scheduling a transmission in a TTI m and the measurement result for the sidelink control signaling is higher than a power threshold, the UE may exclude the candidate resources according to the received sidelink control signaling. The measurement result may be Reference Signal Received Power (RSRP). More specifically, the measurement result may be PSCCH-RSRP or PSSCH-RSRP. The sidelink control signaling may schedule/indicate the resources of the scheduled transmission and/or periodicity of the scheduled transmission, P_{rsvp_RX}. The excluded candidate resources according to the received sidelink control signaling are the resources of next one or multiple scheduled transmission(s) based on the resources of the scheduled transmission and/or periodicity of the scheduled transmission. The next multiple scheduled transmissions may be with period P_{rsvp_RX} within time interval [z, z+T_{scal}]. The power threshold is determined based on priority_{RX} (priority value indicated by the received sidelink control signaling) and priority_{TX} (priority value provided by the UE's higher layer). The association between the power threshold and (priority_{RX}, priority_{TX}) is configured by higher layer (e.g., configuration of the sidelink (communication) resource pool).

In NR duplex operation on Uu interface (e.g., [4] RP-220633), subband (non-overlapping) full duplex, noted as Non-Overlapping Sub-Band/Subband Full Duplex (SBFD), is considered. The network node (e.g., Next Generation Node B (gNB)) can simultaneously perform Downlink (DL) transmission in one sub-band and perform UL reception in another sub-band, wherein the one sub-band and the another sub-band are non-overlapped in frequency domain. In the WO2022211895A1 disclosure on PC5 interface ([9] WO2022211895A1, titled “SIDELINK FEEDBACK FOR FULL DUPLEX USER EQUIPMENT”), a SBFD-capable UE may simultaneously perform sidelink feedback transmission in a first set of sidelink feedback resources and perform sidelink feedback reception in a second set of sidelink feedback resources. The first set of sidelink feedback resources and the second set of sidelink feedback resources are partitioned, from a PSFCH resource pool, with a set of gap resources in frequency domain.

Considering possible scenarios in the future, full duplex operation may be supported in sidelink. Given some technologies (e.g., antenna/Radio Frequency (RF) and algorithm design, antenna isolation, TX Intermodulation (IM) suppression in the Reception (RX) part, filtering and digital interference suppression, self-interference cancellation/suppression, and/or inter-subband Cross-Link Interference (CLI) cancellation/suppression), a sidelink UE with multiple antenna elements/panels and/or a Transceiver Unit (TXRU) of an antenna array may be capable to operate full duplex. SBFD may be a feasible approach to achieve full duplex operation not only for the network node but also for the UE (e.g., a high-end UE or a full-duplex-capable UE). For instance, a vehicle may be equipped with a former antenna array/panel and a latter antenna array/panel. Good antenna isolation and interference cancellation/suppression may allow the vehicle to simultaneously perform sidelink transmission via the former antenna array/panel and perform sidelink reception via the latter antenna array/panel, and vice versa.

However, the [9] WO2022211895A1 disclosure restricts SBFD operation on sidelink feedback transmission/reception (i.e., PSFCH transmission/reception) within one sidelink resource pool. To further improve system capacity in sidelink, reduce latency of sidelink service, enhance efficiency and flexibility on sidelink resource utilization, it will be possible to consider full duplex operation on sidelink control/data transmission/reception (e.g., PSCCH/PSSCH transmission/reception) as well. Moreover, within a sidelink Bandwidth Part (BWP) or a sidelink carrier/cell, there may be multiple sidelink resource pools in one sidelink slot. If SBFD operation is applied/performed per sidelink resource pool, it will be too complex for SBFD UE to perform sidelink communication in multiple sidelink resource pools. Furthermore, current sensing-based resource exclusion and selection (for PSSCH resources) in NR sidelink resource allocation mode 2 is designed/specified for half-duplex UE. When full duplex operation is introduced for PSCCH/PSSCH, it will need some modifications.

To deal with above issues on full duplex SL operation, some concepts, mechanisms, methods, and/or embodiments are provided below.

### Concept A

A UE may have configuration of a set of sidelink resource pools within one sidelink BWP or in one sidelink carrier/cell. The set of sidelink resource pools may be FDMed and/or TDMed. The UE may perform sidelink communication in one or multiple sidelink resource pools, of the set of sidelink resource pools, in at least a first slot/occasion. Preferably in certain embodiments, the one or multiple sidelink resource pools may comprise a first sidelink resource pool and/or a second sidelink resource pool.

In a first embodiment A1, the UE may divide/partition full/all frequency resources of the first sidelink (control/data) resource pool into at least a first subset of frequency resources and a second subset of frequency resources in frequency domain. In the first slot/occasion, the UE may perform a first sidelink (control/data) transmission in a first sidelink (control/data) resource in the first subset of frequency resources, and the UE may perform a second sidelink (control/data) reception in a second sidelink (control/data) resource in the second subset of frequency resources. Preferably in certain embodiments, the UE may perform sidelink (control/data) reception/monitoring in the second subset of frequency resources.

Preferably in certain embodiments, the first sidelink (control/data) transmission may be/mean a first PSCCH transmission and/or a first PSSCH transmission. The first sidelink (control/data) resource may be/mean a first PSCCH resource and/or a first PSSCH resource.

Preferably in certain embodiments, the second sidelink (control/data) reception may be/mean a second PSCCH reception and/or a second PSSCH reception. The second sidelink (control/data) resource may be/mean a second PSCCH resource and/or a second PSSCH resource.

Preferably in certain embodiments, in the first slot/occasion, the first subset of frequency resources may be utilized for PSCCH/PSSCH transmission. Preferably in certain embodiments, in the first slot/occasion, the second subset of frequency resources may be utilized for PSCCH/PSSCH reception.

Preferably in certain embodiments, the first subset of frequency resources and the second subset of frequency resources may be separated with at least a specific gap in frequency domain. The specific gap is, in frequency domain, between the first subset of frequency resources and the second subset of frequency resources. The number/size of the specific gap may be configured in configuration of the first sidelink resource pool or determined/derived by the UE (e.g., based on the UE capability).

Preferably in certain embodiments, the division/partition of the first subset of frequency resources and the second subset of frequency resources may be configured or determined based on configuration of the first sidelink resource pool. For instance, the first sidelink resource pools includes 10 sub-channels in frequency domain, noted as sub-channels #0˜9. The configuration of the first sidelink resource pool may indicate/configure the specific gap as sub-channels #4˜5. The UE may determine/derive sub-channels #0˜3 and sub-channels #6˜9 as being a different subset of frequency resources.

Preferably and/or alternatively, the division/partition of the first subset of frequency resources and the second subset of frequency resources may be determined/derived by the UE. Preferably in certain embodiments, the first subset of frequency resources may comprise only the first sidelink (control/data) resource. The division/partition of the first subset of frequency resources and the second subset of frequency resources may be determined/derived based on the first sidelink (control/data) resource. When the UE determines the first sidelink (control/data) transmission or the first sidelink (control/data) resource, the UE may derive/determine the second subset of frequency resources based on the first sidelink (control/data) resource and/or the specific gap. Preferably in certain embodiments, the first sidelink (control/data) transmission may be with highest priority (i.e., lowest priority value) comparing to other sidelink (control/data) transmission/reception in the first subset of frequency resources. Preferably in certain embodiments, the first sidelink (control/data) transmission may be with highest priority (i.e., lowest priority value) comparing to other sidelink (control/data) transmission/reception in the first sidelink resource pool. For instance, the first sidelink resource pools includes 10 sub-channels in frequency domain, noted as sub-channels #0˜9. In the first slot, the UE may determine the first PSSCH resource as sub-channels #2˜4. If the specific gap is smaller than or equal to one sub-channel size, the UE may determine/derive the second subset of frequency resources as sub-channels #0 and #6˜9. The UE may receive/monitor PSCCH in sub-channels #0 and #6˜9 in the first slot. The UE may not receive/monitor PSCCH in sub-channels #1˜5 in the first slot. If the specific gap is larger than one sub-channel size and is smaller than or equal to two sub-channel sizes, the UE may determine/derive the second subset of frequency resources as sub-channels #7˜9. The UE may receive/monitor PSCCH in sub-channels #7˜9 in the first slot. The UE may not receive/monitor PSCCH in sub-channels #0˜6 in the first slot.

In a second embodiment A2, in the first slot/occasion, the UE may perform a first sidelink (control/data/feedback) transmission in a first sidelink resource in the first sidelink resource pool, and the UE may perform sidelink (control/data/feedback) reception/monitoring in the second sidelink resource pool. Preferably in certain embodiments, the first sidelink (control/data/feedback) transmission may be with highest priority (i.e., lowest priority value) comparing to other sidelink (control/data) transmission/reception in the first sidelink resource pool. Preferably in certain embodiments, the first sidelink (control/data/feedback) transmission may be with highest priority (i.e., lowest priority value) comparing to other sidelink (control/data) transmission/reception in the one sidelink BWP or one sidelink carrier/cell. Preferably in certain embodiments, the UE may not divide/partition (full/all) frequency resources of the first sidelink resource pool into different subsets of frequency resources for full duplex operation. More specifically, in one sidelink resource pool, the UE is restricted/allowed to perform either sidelink (control/data/feedback) transmission or sidelink (control/data/feedback) reception/monitoring at a timing (e.g., in a symbol or in the first slot/occasion). In one sidelink resource pool, the UE prevents/excludes from or is not allowed to perform sidelink (control/data/feedback) transmission and sidelink (control/data/feedback) reception/monitoring simultaneously at a timing (e.g., in a symbol or in the first slot/occasion). Preferably in certain embodiments, in the first slot/occasion, the UE may not perform sidelink (control/data/feedback) reception/monitoring in the first sidelink resource pool (since or in response that the UE performs the first sidelink (control/data/feedback) transmission in the first sidelink resource pool). Preferably in certain embodiments, in the first slot/occasion, the UE may not perform sidelink (control/data/feedback) transmission in the second sidelink resource pool (since or in response that the UE performs the sidelink (control/data/feedback) reception/monitoring in the second sidelink resource pool).

Preferably in certain embodiments, the first sidelink (control/data) transmission may be/mean a first PSCCH transmission and/or a first PSSCH transmission. Preferably in certain embodiments, the first sidelink (feedback) transmission may be/mean a first PSFCH transmission. Preferably in certain embodiments, the first sidelink (control/data) resource may be/mean a first PSCCH transmission and/or a first PSSCH resource. Preferably in certain embodiments, the first sidelink (feedback) resource may be/mean a first PSFCH resource.

Preferably in certain embodiments, the sidelink (control/data) reception/monitoring may be/mean PSCCH and/or PSSCH reception/monitoring. Preferably in certain embodiments, the sidelink (feedback) reception/monitoring may be/mean PSFCH reception/monitoring/detecting.

Preferably in certain embodiments, the first sidelink resource pool and the second sidelink resource pool may be separated with at least a specific gap in frequency domain. The specific gap is, in frequency domain, between the first sidelink resource pool and the second sidelink resource pool. The number/size of the specific gap may be configured in configuration of the first and/or the second sidelink resource pool or determined/derived by the UE (e.g., based on the UE capability). Preferably in certain embodiments, the specific gap may be in units of PRB or subcarrier in frequency domain.

Preferably and/or alternatively, when the UE determines the first sidelink (control/data/feedback) transmission or the first sidelink (control/data/feedback) resource, the UE may derive/determine the second sidelink resource pool based on the first sidelink resource pool and/or the specific gap. Preferably and/or alternatively, when the UE determines the first sidelink (control/data/feedback) transmission or the first sidelink (control/data/feedback) resource, the UE may derive/determine the second sidelink resource pool based on the first sidelink (control/data) resource and/or the specific gap. For instance, in the first slot, the UE may determine to perform the first PSSCH transmission in the first PSSCH resource in the first sidelink resource pool. Preferably in certain embodiments, if some frequency gap between the first sidelink resource pool and another sidelink resource pool is larger than or equal to the specific gap (e.g., any frequency resources of the another sidelink resource pool is not overlapped with the specific gap in frequency domain), the UE may determine/derive the another sidelink resource pool as the second sidelink resource pool. Preferably and/or alternatively, if some frequency gap between the first sidelink resource pool and another sidelink resource pool is smaller than the specific gap (e.g., some frequency resources of the another sidelink resource pool is overlapped with the specific gap in frequency domain), the UE may not determine/derive the another sidelink resource pool as the second sidelink resource pool. The UE may perform neither sidelink (control/data/feedback) transmission nor sidelink (control/data/feedback) reception/monitoring in the another sidelink resource pool in the first slot.

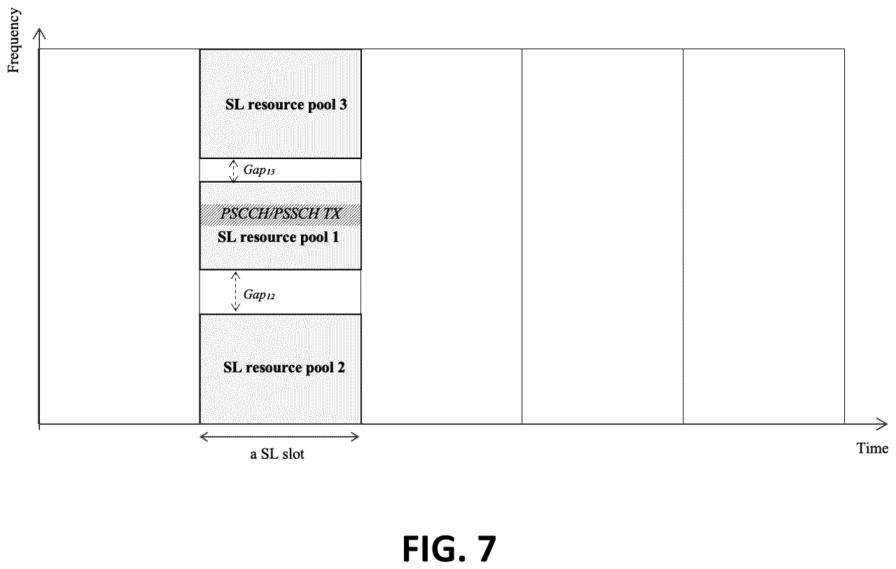

For instance, in the first slot, the UE may determine to perform the first PSSCH transmission in the first PSSCH resource in the first sidelink resource pool (e.g., PSCCH/PSSCH TX in SL resource pool 1 in FIG. 7). Preferably in certain embodiments, if the some frequency gap between the first PSSCH resource and another sidelink resource pool is larger than or equal to the specific gap, the UE may determine/derive the another sidelink resource pool as the second sidelink resource pool (e.g., in FIG. 7, SL resource pool 2 with Gap₁₂>specific gap). Preferably and/or alternatively, if the some frequency gap between the first PSSCH resource and another sidelink resource pool is smaller than the specific gap (e.g., in FIG. 7, SL resource pool 3 with Gap₁₃<specific gap), the UE may not determine/derive the another sidelink resource pool as the second sidelink resource pool. The UE may perform neither sidelink (control/data/feedback) transmission nor sidelink (control/data/feedback) reception/monitoring in the another sidelink resource pool (e.g., in FIG. 7, SL resource pool 3 with Gap₁₃<specific gap) in the first slot.

Preferably in certain embodiments, in the first slot/occasion, the UE may perform sidelink (control/data/feedback) transmission(s) in at most one sidelink resource pool (e.g., the first sidelink resource pool). Preferably in certain embodiments, in the first slot/occasion, the UE may perform sidelink (control/data/feedback) reception/monitoring in one or more sidelink resource pool(s) (e.g., comprising at least the second sidelink resource pool).

### Concept B

A UE may have configuration of a set of sidelink resource pools within one sidelink BWP or one sidelink carrier/cell. The set of sidelink resource pools may be FDMed and/or TDMed. The UE may perform sidelink communication in one or multiple sidelink resource pools, of the set of sidelink resource pools, in at least a first slot/occasion. Preferably in certain embodiments, the one or multiple sidelink resource pool may comprise a first sidelink resource pool and/or a second sidelink resource pool.

The UE may trigger/request sensing-based resource (re-)selection, in a second slot/occasion n, for determining sidelink (control/data) resource/transmission in one sidelink resource pool of the set of sidelink resource pool. Preferably in certain embodiments, (in response to the trigger/request,) the UE may determine a plurality of candidate occasions in the one sidelink resource pool. Preferably in certain embodiments, the plurality of candidate occasions may be within a resource selection window/duration, e.g., a time interval [n+T₁, n+T₂]. The UE may determine a plurality of candidate sidelink resources, which are/comprises (all) sidelink resources in the plurality of candidate occasions in the one sidelink resource pool. In other words, (all) sidelink resources in the plurality of candidate occasions in the one sidelink resource pool may be considered/set/determined as candidate sidelink resources (of the plurality of candidate signal resources).

The UE may determine a set of valid/identified sidelink resources, from the plurality of candidate sidelink resources, based on sensing result. Preferably in certain embodiments, the UE may determine the set of valid/identified sidelink resources based on the sensing result within a sensing window/duration, e.g., a time interval [n-T₀, n−T_{proc0}]. Preferably in certain embodiments, the UE may exclude some candidate sidelink resources, among/from the plurality of candidate sidelink resources, in response to non-monitoring in some slot(s)/occasion(s). Preferably in certain embodiments, the UE may exclude some candidate sidelink resources, among/from the plurality of candidate sidelink resources, based on the sensing result (e.g., reception of sidelink control information or sidelink resource reservation information from other UE(s)). Preferably in certain embodiments, the UE may determine the set of valid/identified sidelink resources from remaining candidate sidelink resources after the exclusion. Preferably in certain embodiments, the set of valid/identified sidelink resources may comprise (all or part of) remaining candidate sidelink resources after the exclusion.

The set of valid/identified sidelink resources may be reported to higher layers of the UE. (The higher layers of) the UE may select the one or more sidelink resources from the set of valid/identified sidelink resources. The UE may perform one or more sidelink control and/or data transmissions on the one or more sidelink resources. Preferably in certain embodiments, the one or more sidelink resources may be in different slots/occasions in the one sidelink resource pool.

Preferably in certain embodiments, the UE may perform sidelink transmission and monitoring/reception simultaneously in the first slot/occasion within the one sidelink BWP or the one sidelink carrier/cell. The first slot/occasion is within the sensing window/duration.

The concept of concept B is that the UE may perform candidate sidelink resource exclusion due to non-monitoring with considering frequency domain as well. (In NR R16/17 SL, resource exclusion due to non-monitoring only considers non-monitoring slot/occasion in time domain, e.g., the first excluding step shown as step 1 in FIG. 6). More specifically, if the UE does not monitor/sense a first frequency region in the first slot/occasion, the excluding step of non-monitoring may apply on candidate sidelink resources within at least the first frequency region. (Some) Candidate sidelink resources outside the first frequency region may be kept (i.e., not excluded in response to the non-monitoring in the first frequency region).

Preferably in certain embodiments, the UE may not monitor/sense the first frequency region in the first slot/occasion (e.g., the UE perform sidelink or uplink transmission within the first frequency region in the first slot/occasion), and the UE may monitor/sense a second frequency region in the first slot/occasion. The UE may determine a first set of slots/occasions based on the first slot/occasion and a set of periodicities.

Preferably in certain embodiments, the first set of slots/occasions may be within the resource selection window/duration. Preferably in certain embodiments, the set of periodicities may comprise (any) periodicity configured in the one sidelink resource pool. For instance, if the first slot/occasion is indexed as slot/occasion z, the first set of slots/occasions may comprise slot(s)/occasion(s) “z+P_{any}” in the one sidelink resource pool. P_{any} may mean (any) periodicity configured in the one sidelink resource pool.

In one method, the UE may perform an excluding step of non-monitoring on (all) candidate sidelink resources within the first frequency region. The UE may exclude (all) candidate sidelink resources within the first frequency region in the first set of slots/occasions (in response to the non-monitoring in the first frequency region). Candidate sidelink resources within the second frequency region in the first set of slots/occasions may be kept (i.e., not excluded in response to the non-monitoring in the first frequency region). Preferably in certain embodiments, the first frequency region and the second frequency region are within the same one sidelink BWP or the same one sidelink carrier/cell.

In another method, if the first frequency region and the second frequency region are within the same one sidelink resource pool, the UE may perform the excluding step of non-monitoring on (all) candidate sidelink resources within the one sidelink resource pool. In other words, once the UE does not monitor/sense the first frequency region of the one sidelink resource pool in the first slot/occasion, the UE may perform the excluding step of non-monitoring on (all) candidate sidelink resources within the one sidelink resource pool. The UE may exclude (all) candidate sidelink resources within the one sidelink resource pool in the first set of slots/occasions (in response to the non-monitoring in the first frequency region). Candidate sidelink resources within other sidelink resource pool(s) may be kept (i.e., not excluded in response to the non-monitoring in the first frequency region), if the UE triggers/requests other sensing-based resource (re-)selection for determining sidelink (control/data) resource/transmission in the other sidelink resource pool(s) of the set of sidelink resource pool. Preferably in certain embodiments, if the first frequency region is within the one sidelink resource pool and the second frequency region is within another sidelink resource pool (i.e., the first frequency region and the second frequency region are within different sidelink resource pools), the UE may perform the excluding step of non-monitoring on (all) candidate sidelink resources within the one sidelink resource pool. The UE may exclude (all) candidate sidelink resources within the one sidelink resource pool in the first set of slots/occasions (in response to the non-monitoring in the first frequency region). Candidate sidelink resources within the another sidelink resource pool may be kept (i.e., not excluded in response to the non-monitoring in the first frequency region), if the UE triggers/requests another sensing-based resource (re-)selection for determining sidelink (control/data) resource/transmission in the another sidelink resource pool of the set of sidelink resource pools.

In a first embodiment B1 (for either or both of methods), the UE may divide/partition full/all frequency resources of a first sidelink (control/data) resource pool into at least a first subset of frequency resources and a second subset of frequency resources in frequency domain. In the first slot/occasion, the UE may perform a first sidelink (control/data) transmission in a first sidelink (control/data) resource in the first subset of frequency resources. In the first slot/occasion, the UE may perform sidelink (control/data) reception/monitoring in the second subset of frequency resources. Preferably in certain embodiments, the division/partition of the first subset of frequency resources and the second subset of frequency resources may refer embodiment A1 in Concept A.

Preferably in certain embodiments, the first subset of frequency resources and the second subset of frequency resources are non-overlapped in frequency domain. Preferably in certain embodiments, the first subset of frequency resources and the second subset of frequency resources may be separated with at least a specific gap in frequency domain. The specific gap is, in frequency domain, between the first subset of frequency resources and the second subset of frequency resources. The number/size of the specific gap may be configured in configuration of the first sidelink resource pool or determined/derived by the UE (e.g., based on the UE capability).

The UE may trigger/request the sensing-based resource (re-)selection, in the second slot/occasion n, for determining sidelink (control/data) resource/transmission in the first sidelink resource pool.

Preferably in certain embodiments, the first frequency region may comprise the first subset of frequency resources and/or the specific gap. The first frequency region does not comprise the second subset of frequency resources. Preferably in certain embodiments, the second frequency region may comprise the second subset of frequency resources. The second frequency region does not comprise the first subset of frequency resources and/or the specific gap.

Preferably in certain embodiments, for TS 38.214, one text proposal B1 may be applied for reflecting the concept/embodiment.

In a second embodiment B2 (for either or both methods), in the first slot/occasion, the UE may perform a first sidelink (control/data) transmission in a first sidelink resource in the first sidelink resource pool, and the UE may perform sidelink (control/data) reception/monitoring in the second sidelink resource pool. The first sidelink resource pool and the second sidelink resource pool may refer to embodiment A2 in Concept A.

Preferably in certain embodiments, the first frequency region may comprise/mean the first sidelink resource pool. Preferably and/or alternatively, the first frequency region may be within the first sidelink resource pool. The first frequency region may not be comprised within the second sidelink resource pool. Preferably in certain embodiments, the second frequency region may comprise/mean the second sidelink resource pool. Preferably and/or alternatively, the second frequency region may be within the second sidelink resource pool. The second frequency region may not be comprised within the first sidelink resource pool.

Preferably in certain embodiments, the UE may trigger/request the sensing-based resource (re-)selection, in the second slot/occasion n, for determining sidelink (control/data) resource/transmission in the first sidelink resource pool. Preferably in certain embodiments, the UE may perform excluding step of non-monitoring on (part of all) candidate sidelink resources within the first sidelink resource pool, in response to the non-monitoring in the first frequency region (based on either or both of methods).

Preferably in certain embodiments, the UE may trigger/request sensing-based resource (re-)selection, in the second slot/occasion n, for determining sidelink (control/data) resource/transmission in the second sidelink resource pool. Preferably in certain embodiments, the UE may not perform excluding step of non-monitoring on (part of all) candidate sidelink resources within the second sidelink resource pool, in response to the non-monitoring in the first frequency region.

Preferably in certain embodiments, for TS 38.214, one text proposal B2 may be applied for reflecting the concept/embodiment.

It is noted that any of the methods, alternatives, steps, examples, and embodiments proposed above and herein may be applied independently, individually, and/or with multiple methods, alternatives, steps, examples, and embodiments combined together.

The following aspects and embodiments can be applied to the above and herein concepts, embodiments, and examples. Various aspects, concepts, methods embodiments, and examples of the present invention are provided below.

Preferably in certain embodiments, the UE may be capable to operate (sidelink) full duplex, SBFD. Preferably in certain embodiments, the UE may be a (sidelink) full-duplex-capable UE. Preferably in certain embodiments, the UE may be configured/enable to perform (sidelink) full duplex operation. Preferably in certain embodiments, the UE is equipped with multiple antenna elements/panels and/or TXRU of antenna array.

Preferably in certain embodiments, the concepts, methods, and/or embodiments may be utilized for sidelink reference signal transmission/reception. Preferably in certain embodiments, the concepts, methods, and/or embodiments may be utilized for sensing-based resource selection for sidelink reference signal transmission. Preferably in certain embodiments, the sidelink control/data transmission may be changed/replaced as sidelink reference signal transmission. Preferably in certain embodiments, the sidelink resource pool may be a sidelink resource pool enabled/configured/supported for sidelink reference signal transmission/reception, e.g., a dedicated resource pool for sidelink reference signal or a shared sidelink resource pool (e.g., a sidelink resource pool enabled/configured/supported for both sidelink data transmission/reception and sidelink reference signal transmission/reception).

Preferably in certain embodiments, the sidelink reference signal may be any one of SL Positioning Reference Signal (PRS) or SL beam management RS. Preferably in certain embodiments, the sidelink reference signal may be SL Channel State Information Based Reference Signal (CSI-RS) (for beam management), which is not combined within a PSSCH (bandwidth) in frequency domain. Preferably in certain embodiments, the sidelink reference signal may require large bandwidth. Preferably in certain embodiments, the sidelink reference signal may be utilized for (High-Resolution) localization, sensing, or imaging. Preferably in certain embodiments, the sidelink reference signal may be utilized for beam management (e.g., in Frequency Range 2 (FR2)). Preferably in certain embodiments, bandwidth of a sidelink reference signal may comprise part of resource blocks of the sidelink resource pool for sidelink reference signal. Preferably and/or alternatively, bandwidth of a sidelink reference signal may comprise all resource blocks of the sidelink resource pool for sidelink reference signal.

Preferably in certain embodiments, the SL PRS may be applied/utilized for (absolute and/or relative) positioning and/or ranging.

Preferably in certain embodiments, the SL PRS may be applied/utilized for any of time-based positioning/ranging methods and/or angle-based positioning/ranging methods. Preferably in certain embodiments, the SL PRS may be applied/utilized for any of Time Difference of Arrival (TDoA), Round Trip Time (RTT)-based positioning/ranging, Angle of Arrival (AoA), Angle of Departure (AoD), or carrier phase measurement based positioning.

Preferably in certain embodiments, the slot/occasion may be/mean any of slot, sub-slot or TTI for sidelink. Preferably in certain embodiments, the slot/occasion may be/mean time-domain resource (pattern unit) for sidelink (control/data/feedback) transmission. Preferably in certain embodiments, the slot/occasion may be/mean a number of symbols (e.g., M) for (a time resource pattern of) sidelink.

Preferably in certain embodiments, the candidate slot/occasion may be/mean any of slot, sub-slot or TTI for sidelink. Preferably in certain embodiments, the candidate slot/occasion may be/mean time-domain resource (pattern unit) for sidelink (control/data/feedback) transmission. Preferably in certain embodiments, the candidate slot/occasion may be/mean a number of symbols (e.g., M) for (a time resource pattern of) sidelink.

Preferably in certain embodiments, the slot may mean a sidelink slot. Preferably in certain embodiments, the slot may be represented/replaced as a TTI.

Preferably in certain embodiments, the sidelink slot may mean slot for sidelink. Preferably in certain embodiments, a TTI may be a subframe (for sidelink) or slot (for sidelink) or sub-slot (for sidelink). Preferably in certain embodiments, a TTI comprises multiple symbols, e.g., 12 or 14 symbols. Preferably in certain embodiments, a TTI may be a slot (fully/partially) comprising sidelink symbols. Preferably in certain embodiments, a TTI may mean a transmission time interval for a sidelink (data) transmission. Preferably in certain embodiments, a sidelink slot or a slot for sidelink may contain all Orthogonal Frequency Division Multiplexing (OFDM) symbols available for sidelink transmission. Preferably in certain embodiments, a sidelink slot or a slot for sidelink may contain a consecutive number of symbols available for sidelink transmission. Preferably in certain embodiments, a sidelink slot or a slot for sidelink means that a slot is included/comprised in a sidelink resource pool.

Preferably in certain embodiments, the symbol may mean a symbol indicated/configured for sidelink.

Preferably in certain embodiments, the slot may mean/comprise sidelink slot associated with the (sidelink) resource pool. Preferably in certain embodiments, the slot may not mean/comprise a sidelink slot associated with other (sidelink) resource pool.

Preferably in certain embodiments, the slot may mean/comprise sidelink slot in the one sidelink BWP or the one sidelink carrier/cell.

Preferably in certain embodiments, the contiguous/consecutive slots may mean contiguous sidelink slots in/for the (sidelink) resource pool.

Preferably in certain embodiments, the contiguous/consecutive slots may or may not be contiguous/consecutive in physical slots. This means that the contiguous/consecutive slots in the sidelink resource pool may be not contiguous/consecutive from the aspect of physical slot. Preferably in certain embodiments, the contiguous/consecutive slots may or may not be contiguous/consecutive in sidelink slots in/for a sidelink BWP or a sidelink carrier/cell. This means that the contiguous/consecutive slots in the (sidelink) resource pool may be not contiguous/consecutive from the aspect of sidelink slots in a sidelink BWP or a sidelink carrier/cell. Preferably in certain embodiments, there may be one or more (sidelink) resource pools in a sidelink BWP or a sidelink carrier/cell.

Preferably in certain embodiments, a sub-channel is a unit for sidelink resource allocation/scheduling (for PSSCH). Preferably in certain embodiments, a sub-channel may comprise multiple contiguous PRBs in frequency domain. Preferably in certain embodiments, the number of PRBs for each sub-channel may be (pre-)configured for a sidelink resource pool. Preferably in certain embodiments, a sidelink resource pool (pre-)configuration may indicate/configure the number of PRBs for each sub-channel. Preferably in certain embodiments, the number of PRBs for each sub-channel may be any of 10, 12, 15, 20, 25, 50, 75, 100. Preferably in certain embodiments, a sub-channel may be represented as a unit for sidelink resource allocation/scheduling. Preferably in certain embodiments, a sub-channel may mean a set of consecutive PRBs in frequency domain. Preferably in certain embodiments, a sub-channel may mean a set of consecutive resource elements in frequency domain.

Preferably in certain embodiments, the first UE may have/maintain/establish multiple sidelink links/connections on PC5 interface. For different sidelink links/connections, the first UE may perform sidelink transmission/reception to/from different paired UE(s).

Preferably in certain embodiments, the first UE may have/maintain/establish a first sidelink link/connection and a second sidelink link/connection. The paired UE of the first sidelink link/connection may be different from the paired UE of the second sidelink link/connection. Preferably in certain embodiments, the sidelink logical channel(s) associated with (the paired UE of) the first sidelink link/connection are separate/independent from the sidelink logical channel(s) associated with (the paired UE of) the second sidelink link/connection.

Preferably in certain embodiments, the UE may be/mean/comprise/replace a device.

Preferably in certain embodiments, the sidelink transmission/reception may be UE-to-UE transmission/reception. Preferably in certain embodiments, the sidelink transmission/reception may be device-to-device transmission/reception. Preferably in certain embodiments, the sidelink transmission/reception may be Vehicle-to-Everything (V2X) transmission/reception. Preferably in certain embodiments, the sidelink transmission/reception may be Pedestrian-to-Everything (P2X) transmission/reception. Preferably in certain embodiments, the sidelink transmission/reception may be on PC5 interface.

Preferably in certain embodiments, the PC5 interface may be wireless interface for communication between device and device. Preferably in certain embodiments, the PC5 interface may be a wireless interface for communication between devices. Preferably in certain embodiments, the PC5 interface may be a wireless interface for communication between UEs. Preferably in certain embodiments, the PC5 interface may be a wireless interface for V2X or P2X communication. Preferably in certain embodiments, the Uu interface may be a wireless interface for communication between network node and device. Preferably in certain embodiments, the Uu interface may be a wireless interface for communication between network node and UE.

Preferably in certain embodiments, the first UE may be a first device. Preferably in certain embodiments, the first UE may be a vehicle UE. Preferably in certain embodiments, the first UE may be a V2X UE.

Preferably in certain embodiments, the second UE may be a second device. Preferably in certain embodiments, the second UE may be a vehicle UE. Preferably in certain embodiments, the second device may be a V2X UE.

Preferably in certain embodiments, the first UE and the second device are different devices. Various aspects, concepts, methods embodiments, and examples of the present invention are provided below.

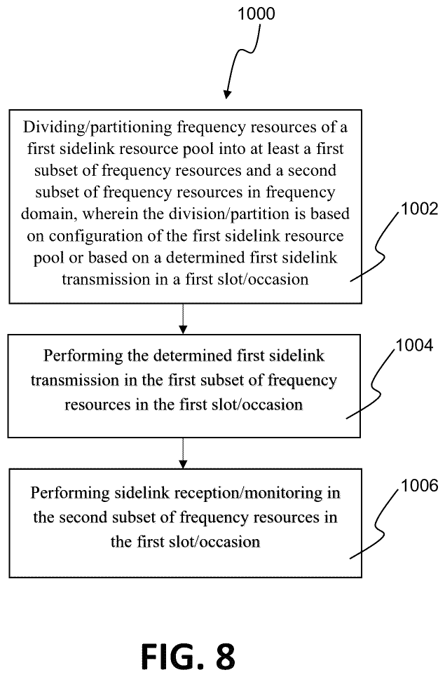

Referring to FIG. 8, with this and other concepts, systems, and methods of the present invention, a method 1000 for a first device in a wireless communication system comprises dividing/partitioning frequency resources of a first sidelink resource pool into at least a first subset of frequency resources and a second subset of frequency resources in frequency domain, wherein the division/partition is based on configuration of the first sidelink resource pool or based on a determined first sidelink transmission in a first slot/occasion (step 1002), performing the determined first sidelink transmission in the first subset of frequency resources in the first slot/occasion (step 1004), and performing sidelink reception/monitoring in the second subset of frequency resources in the first slot/occasion (step 1006).

Referring back to FIGS. 3 and 4, in one or more embodiments from the perspective of a first device, the device 300 includes a program code 312 stored in memory 310 of the transmitter. The CPU 308 could execute program code 312 to: (i) divide/partition frequency resources of a first sidelink resource pool into at least a first subset of frequency resources and a second subset of frequency resources in frequency domain, wherein the division/partition is based on configuration of the first sidelink resource pool or based on a determined first sidelink transmission in a first slot/occasion; (ii) perform the determined first sidelink transmission in the first subset of frequency resources in the first slot/occasion; and (iii) perform sidelink reception/monitoring in the second subset of frequency resources in the first slot/occasion. Moreover, the CPU 308 can execute the program code 312 to perform all of the described actions, steps, and methods described above, below, or otherwise herein.

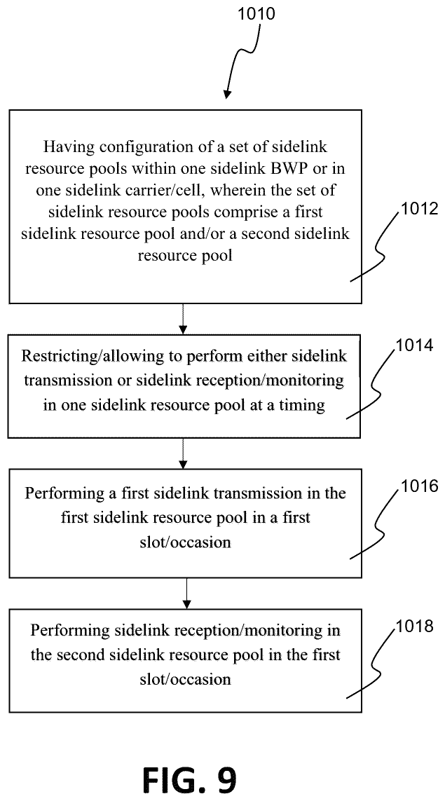

Referring to FIG. 9, with this and other concepts, systems, and methods of the present invention, a method 1010 for a first device in a wireless communication system comprises having configuration of a set of sidelink resource pools within one sidelink BWP or in one sidelink carrier/cell, wherein the set of sidelink resource pools comprise a first sidelink resource pool and/or a second sidelink resource pool (step 1012), restricting/allowing to perform either sidelink transmission or sidelink reception/monitoring in one sidelink resource pool at a timing (step 1014), performing a first sidelink transmission in the first sidelink resource pool in a first slot/occasion (step 1016), and performing sidelink reception/monitoring in the second sidelink resource pool in the first slot/occasion (step 1018).

Referring back to FIGS. 3 and 4, in one or more embodiments from the perspective of a first device, the device 300 includes a program code 312 stored in memory 310 of the transmitter. The CPU 308 could execute program code 312 to: (i) have configuration of a set of sidelink resource pools within one sidelink BWP or in one sidelink carrier/cell, wherein the set of sidelink resource pools comprise a first sidelink resource pool and/or a second sidelink resource pool; (ii) restrict/allow to perform either sidelink transmission or sidelink reception/monitoring in one sidelink resource pool at a timing; (iii) perform a first sidelink transmission in the first sidelink resource pool in a first slot/occasion; and (iv) perform sidelink reception/monitoring in the second sidelink resource pool in the first slot/occasion. Moreover, the CPU 308 can execute the program code 312 to perform all of the described actions, steps, and methods described above, below, or otherwise herein.

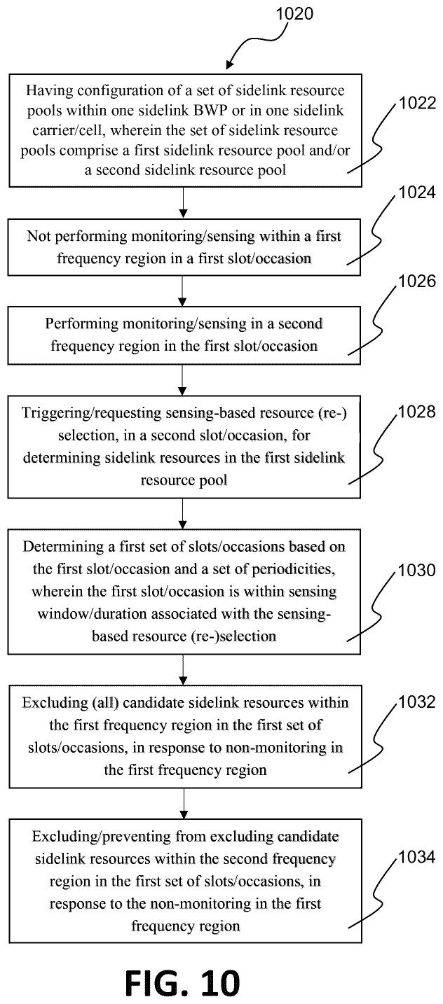

Referring to FIG. 10, with this and other concepts, systems, and methods of the present invention, a method 1020 for a first device in a wireless communication system comprises having configuration of a set of sidelink resource pools within one sidelink BWP or in one sidelink carrier/cell, wherein the set of sidelink resource pools comprise a first sidelink resource pool and/or a second sidelink resource pool (step 1022), not performing monitoring/sensing within a first frequency region in a first slot/occasion (step 1024), performing monitoring/sensing in a second frequency region in the first slot/occasion (step 1026), triggering/requesting sensing-based resource (re-)selection, in a second slot/occasion, for determining sidelink resources in the first sidelink resource pool (step 1028), determining a first set of slots/occasions based on the first slot/occasion and a set of periodicities, wherein the first slot/occasion is within sensing window/duration associated with the sensing-based resource (re-)selection (step 1030), excluding (all) candidate sidelink resources within the first frequency region in the first set of slots/occasions, in response to non-monitoring in the first frequency region (step 1032), and excluding/preventing from excluding candidate sidelink resources within the second frequency region in the first set of slots/occasions, in response to the non-monitoring in the first frequency region (step 1034).

Referring back to FIGS. 3 and 4, in one or more embodiments from the perspective of a first device, the device 300 includes a program code 312 stored in memory 310 of the transmitter. The CPU 308 could execute program code 312 to: (i) have configuration of a set of sidelink resource pools within one sidelink BWP or in one sidelink carrier/cell, wherein the set of sidelink resource pools comprise a first sidelink resource pool and/or a second sidelink resource pool; (ii) not perform monitoring/sensing within a first frequency region in a first slot/occasion; (iii) perform monitoring/sensing in a second frequency region in the first slot/occasion; (iv) trigger/request sensing-based resource (re-)selection, in a second slot/occasion, for determining sidelink resources in the first sidelink resource pool; (v) determine a first set of slots/occasions based on the first slot/occasion and a set of periodicities, wherein the first slot/occasion is within sensing window/duration associated with the sensing-based resource (re-)selection; (vi) exclude (all) candidate sidelink resources within the first frequency region in the first set of slots/occasions, in response to non-monitoring in the first frequency region; and (vii) exclude/prevent from excluding candidate sidelink resources within the second frequency region in the first set of slots/occasions, in response to the non-monitoring in the first frequency region. Moreover, the CPU 308 can execute the program code 312 to perform all of the described actions, steps, and methods described above, below, or otherwise herein.

In various embodiments, the first frequency region and the second frequency region are within the first sidelink resource pool.

In various embodiments, the first frequency region means or is comprised in the first sidelink resource pool, and/or the second frequency region means or is comprised in the second sidelink resource pool.

In various embodiments, the method further comprises the first device not performing the monitoring/sensing within the first frequency region in the first slot/occasion means the first device performing sidelink or uplink transmission within the first frequency region in the first slot/occasion.

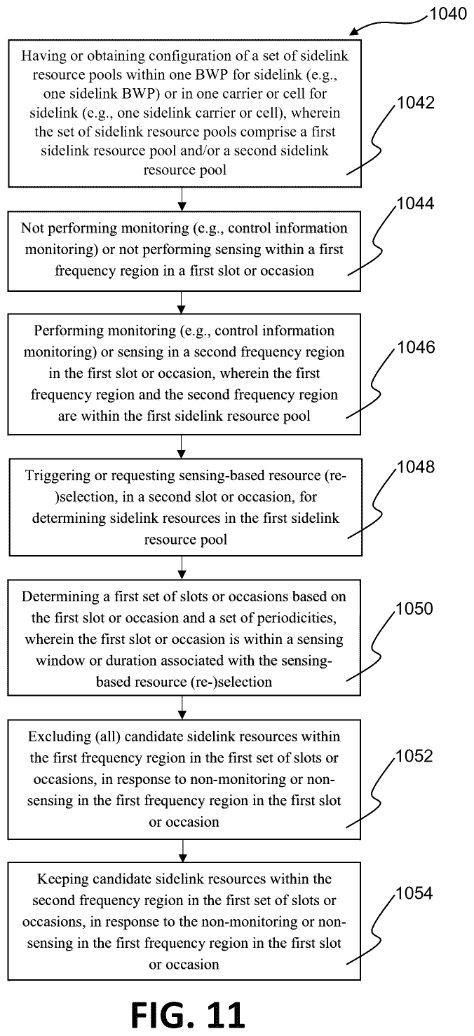

Referring to FIG. 11, with this and other concepts, systems, and methods of the present invention, a method 1040 for a first device in a wireless communication system comprises having or obtaining configuration of a set of sidelink resource pools within one BWP for sidelink (e.g., one sidelink BWP) or in one carrier or cell for sidelink (e.g., one sidelink carrier or cell), wherein the set of sidelink resource pools comprise a first sidelink resource pool and/or a second sidelink resource pool (step 1042), not performing monitoring (e.g., control information monitoring) or not performing sensing within a first frequency region in a first slot or occasion (step 1044), performing monitoring (e.g., control information monitoring) or sensing in a second frequency region in the first slot or occasion, wherein the first frequency region and the second frequency region are within the first sidelink resource pool (1046), triggering or requesting sensing-based resource (re-)selection, in a second slot or occasion, for determining sidelink resources in the first sidelink resource pool (step 1048), determining a first set of slots or occasions based on the first slot or occasion and a set of periodicities, wherein the first slot or occasion is within a sensing window or duration associated with the sensing-based resource (re-)selection (step 1050), excluding (all) candidate sidelink resources within the first frequency region in the first set of slots or occasions, in response to non-monitoring or non-sensing in the first frequency region in the first slot or occasion (step 1052), and keeping candidate sidelink resources within the second frequency region in the first set of slots or occasions, in response to the non-monitoring or non-sensing in the first frequency region in the first slot or occasion (step 1054).

In various embodiments, the method further comprises keeping the candidate sidelink resources within the second frequency region in the first set of slots or occasions comprises the first device preventing from excluding the candidate sidelink resources within the second frequency region in the first set of slots or occasions, in response to the non-monitoring or non-sensing in the first frequency region in the first slot or occasion.

In various embodiments, the method further comprises preventing from excluding candidate sidelink resources within the second sidelink resource pool, in response to the non-monitoring or non-sensing in the first frequency region in the first slot or occasion.

In various embodiments, the method further comprises that the set of periodicities is (pre-)configured or determined based on configuration of the first sidelink resource pool.

In various embodiments, the method further comprises at least one of: triggering or requesting another sensing-based resource (re-)selection, in a third slot or occasion, for determining sidelink resources in the second sidelink resource pool; and/or determining a second set of slots or occasions based on the first slot or occasion and another set of periodicities, wherein the first slot or occasion is within another sensing window or duration associated with the another sensing-based resource (re-)selection; and/or keeping candidate sidelink resources within the second sidelink resource pool in the second set of slots or occasions, in response to the non-monitoring or non-sensing in the first frequency region in the first slot or occasion; and/or preventing excluding candidate sidelink resources within the second sidelink resource pool in the second set of slots or occasions, in response to the non-monitoring or non-sensing in the first frequency region in the first slot or occasion. The another set of periodicities is (pre-)configured or determined based on configuration of the second sidelink resource pool.

In various embodiments, the method further comprises not performing the monitoring or sensing within the first frequency region in the first slot or occasion means or comprises the first device performing sidelink or uplink transmission within the first frequency region in the first slot or occasion.

In various embodiments, the method further comprises at least one of: wherein the first frequency region and the second frequency region are non-overlapped in frequency domain; and/or wherein the first frequency region and the second frequency region are separated with at least a frequency gap in frequency domain; and/or wherein a division or partition of the first frequency region and the second frequency region is (pre-)configured or determined based on configuration of the first sidelink resource pool.

In various embodiments, the method further comprises at least one of: wherein the first device performs first sidelink transmission in a first sidelink resource of the first sidelink resource pool in the first slot or occasion; and/or wherein a division or partition of the first frequency region and the second frequency region is determined based on the first sidelink resource; and/or wherein the first frequency region comprises (only) the first sidelink resource; and/or wherein the second frequency region is determined based on the first sidelink resource and a frequency gap; and/or wherein the first frequency region and the second frequency region are separated with at least the frequency gap in frequency domain.

Referring back to FIGS. 3 and 4, in one or more embodiments from the perspective of a first device, the device 300 includes a program code 312 stored in memory 310 of the transmitter. The CPU 308 could execute program code 312 to: (i) have or obtain configuration of a set of sidelink resource pools within one BWP for sidelink or one carrier or cell for sidelink, wherein the set of sidelink resource pools comprise a first sidelink resource pool and/or a second sidelink resource pool; (ii) not perform monitoring or not performing sensing within a first frequency region in a first slot or occasion; (iii) perform monitoring or sensing in a second frequency region in the first slot or occasion, wherein the first frequency region and the second frequency region are within the first sidelink resource pool; (iv) trigger or request sensing-based resource (re-)selection, in a second slot or occasion, for determining sidelink resources in the first sidelink resource pool; (v) determine a first set of slots or occasions based on the first slot or occasion and a set of periodicities, wherein the first slot or occasion is within a sensing window or duration associated with the sensing-based resource (re-)selection; (vi) exclude (all) candidate sidelink resources within the first frequency region in the first set of slots or occasions, in response to non-monitoring or non-sensing in the first frequency region in the first slot or occasion; and (vii) keep candidate sidelink resources within the second frequency region in the first set of slots or occasions, in response to the non-monitoring or non-sensing in the first frequency region in the first slot or occasion. Moreover, the CPU 308 can execute the program code 312 to perform all of the described actions, steps, and methods described above, below, or otherwise herein.

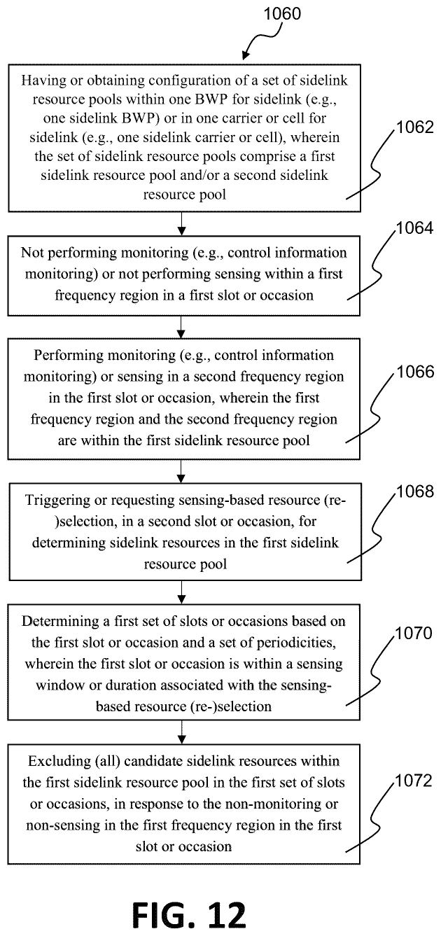

Referring to FIG. 12, with this and other concepts, systems, and methods of the present invention, a method 1060 for a first device in a wireless communication system comprises having or obtaining configuration of a set of sidelink resource pools within one BWP for sidelink (e.g., one sidelink BWP) or in one carrier or cell for sidelink (e.g., one sidelink carrier or cell), wherein the set of sidelink resource pools comprise a first sidelink resource pool and/or a second sidelink resource pool (step 1062), not performing monitoring (e.g., control information monitoring) or not performing sensing within a first frequency region in a first slot or occasion (step 1064), performing monitoring (e.g., control information monitoring) or sensing in a second frequency region in the first slot or occasion, wherein the first frequency region and the second frequency region are within the first sidelink resource pool (step 1066), triggering or requesting sensing-based resource (re-)selection, in a second slot or occasion, for determining sidelink resources in the first sidelink resource pool (step 1068), determining a first set of slots or occasions based on the first slot or occasion and a set of periodicities, wherein the first slot or occasion is within a sensing window or duration associated with the sensing-based resource (re-)selection (step 1070), and excluding (all) candidate sidelink resources within the first sidelink resource pool in the first set of slots or occasions, in response to the non-monitoring or non-sensing in the first frequency region in the first slot or occasion (step 1072).

In various embodiments, the method further comprises preventing from excluding candidate sidelink resources within the second sidelink resource pool, in response to the non-monitoring or non-sensing in the first frequency region in the first slot or occasion.

In various embodiments, the method further comprises that the set of periodicities is (pre-)configured or determined based on configuration of the first sidelink resource pool.

In various embodiments, the method further comprises at least one of: triggering or requesting another sensing-based resource (re-)selection, in a third slot or occasion, for determining sidelink resources in the second sidelink resource pool; and/or determining a second set of slots or occasions based on the first slot or occasion and another set of periodicities, wherein the first slot or occasion is within another sensing window or duration associated with the another sensing-based resource (re-)selection; and/or keeping candidate sidelink resources within the second sidelink resource pool in the second set of slots or occasions, in response to the non-monitoring or non-sensing in the first frequency region in the first slot or occasion; and/or preventing from excluding candidate sidelink resources within the second sidelink resource pool in the second set of slots or occasions, in response to the non-monitoring or non-sensing in the first frequency region in the first slot or occasion. The another set of periodicities is (pre-)configured or determined based on configuration of the second sidelink resource pool.

In various embodiments, not performing the monitoring or not performing sensing within the first frequency region in the first slot or occasion means or comprises the first device performing sidelink or uplink transmission within the first frequency region in the first slot or occasion.

In various embodiments, the method further comprises at least one of: wherein the first frequency region and the second frequency region are non-overlapped in frequency domain; and/or wherein the first frequency region and the second frequency region are separated with at least a frequency gap in frequency domain; and/or wherein a division or partition of the first frequency region and the second frequency region is (pre-)configured or determined based on configuration of the first sidelink resource pool.

In various embodiments, the method further comprises at least one of: wherein the first device performs a first sidelink transmission in a first sidelink resource of the first sidelink resource pool in the first slot or occasion; and/or wherein a division or partition of the first frequency region and the second frequency region is determined based on the first sidelink resource; and/or wherein the first frequency region comprises (only) the first sidelink resource; and/or wherein the second frequency region is determined based on the first sidelink resource and a frequency gap; and/or wherein the first frequency region and the second frequency region are separated with at least the frequency gap in frequency domain.

Referring back to FIGS. 3 and 4, in one or more embodiments from the perspective of a first device, the device 300 includes a program code 312 stored in memory 310 of the transmitter. The CPU 308 could execute program code 312 to: (i) have or obtain configuration of a set of sidelink resource pools within one BWP for sidelink or in one carrier or cell for sidelink, wherein the set of sidelink resource pools comprise a first sidelink resource pool and/or a second sidelink resource pool; (ii) not perform monitoring or not performing sensing within a first frequency region in a first slot or occasion; (iii) perform monitoring or sensing in a second frequency region in the first slot or occasion, wherein the first frequency region and the second frequency region are within the first sidelink resource pool; (iv) trigger or request sensing-based resource (re-)selection, in a second slot or occasion, for determining sidelink resources in the first sidelink resource pool; (v) determine a first set of slots or occasions based on the first slot or occasion and a set of periodicities, wherein the first slot or occasion is within a sensing window or duration associated with the sensing-based resource (re-)selection; and (vi) exclude (all) candidate sidelink resources within the first sidelink resource pool in the first set of slots or occasions, in response to the non-monitoring or non-sensing in the first frequency region in the first slot or occasion. Moreover, the CPU 308 can execute the program code 312 to perform all of the described actions, steps, and methods described above, below, or otherwise herein.

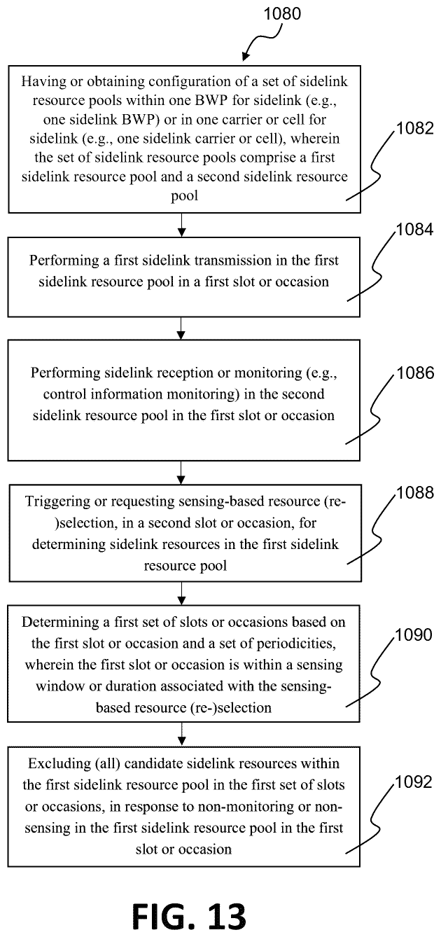

Referring to FIG. 13, with this and other concepts, systems, and methods of the present invention, a method 1080 for a first device in a wireless communication system comprises having or obtaining configuration of a set of sidelink resource pools within one BWP for sidelink (e.g., one sidelink BWP) or in one carrier or cell for sidelink (e.g., one sidelink carrier or cell), wherein the set of sidelink resource pools comprise a first sidelink resource pool and a second sidelink resource pool (step 1082), performing a first sidelink transmission in the first sidelink resource pool in a first slot or occasion (step 1084), performing sidelink reception or monitoring (e.g., control information monitoring) in the second sidelink resource pool in the first slot or occasion (step 1086), triggering or requesting sensing-based resource (re-)selection, in a second slot or occasion, for determining sidelink resources in the first sidelink resource pool (step 1088), determining a first set of slots or occasions based on the first slot or occasion and a set of periodicities, wherein the first slot or occasion is within a sensing window or duration associated with the sensing-based resource (re-)selection (step 1090), and excluding (all) candidate sidelink resources within the first sidelink resource pool in the first set of slots or occasions, in response to non-monitoring or non-sensing in the first sidelink resource pool in the first slot or occasion (step 1092).

In various embodiments, the method further comprises at least one of: not performing monitoring or not performing sensing within the first sidelink resource pool in the first slot or occasion; and/or being restricted to perform either (i) sidelink transmission or (ii) sidelink reception or monitoring or sensing in one sidelink resource pool at a timing; and/or being allowed to perform either (i) sidelink transmission or (ii) sidelink reception or monitoring or sensing in one sidelink resource pool at a timing.

In various embodiments, the method further comprises preventing from excluding candidate sidelink resources within the second sidelink resource pool, in response to the non-monitoring or non-sensing in the first sidelink resource pool in the first slot or occasion.

In various embodiments, the method further comprises that the set of periodicities is (pre-)configured or determined based on configuration of the first sidelink resource pool.

In various embodiments, the method further comprises at least one of: triggering or requesting another sensing-based resource (re-)selection, in a third slot or occasion, for determining sidelink resources in the second sidelink resource pool; and/or determining a second set of slots or occasions based on the first slot or occasion and another set of periodicities, wherein the first slot or occasion is within another sensing window or duration associated with the another sensing-based resource (re-)selection; and/or keeping candidate sidelink resources within the second sidelink resource pool in the second set of slots or occasions, in response to the non-monitoring or non-sensing in the first sidelink resource pool in the first slot or occasion; and/or preventing from excluding candidate sidelink resources within the second sidelink resource pool in the second set of slots or occasions, in response to the non-monitoring or non-sensing in the first sidelink resource pool in the first slot or occasion. The another set of periodicities is (pre-)configured or determined based on configuration of the second sidelink resource pool.

Referring back to FIGS. 3 and 4, in one or more embodiments from the perspective of a first device, the device 300 includes a program code 312 stored in memory 310 of the transmitter. The CPU 308 could execute program code 312 to: (i) have or obtain configuration of a set of sidelink resource pools within one BWP for sidelink or in one carrier or cell for sidelink, wherein the set of sidelink resource pools comprise a first sidelink resource pool and a second sidelink resource pool; (ii) perform a first sidelink transmission in the first sidelink resource pool in a first slot or occasion; (iii) perform sidelink reception or monitoring in the second sidelink resource pool in the first slot or occasion; (iv) trigger or request sensing-based resource (re-)selection, in a second slot or occasion, for determining sidelink resources in the first sidelink resource pool; (v) determine a first set of slots or occasions based on the first slot or occasion and a set of periodicities, wherein the first slot or occasion is within a sensing window or duration associated with the sensing-based resource (re-)selection; and (vi) exclude (all) candidate sidelink resources within the first sidelink resource pool in the first set of slots or occasions, in response to non-monitoring or non-sensing in the first sidelink resource pool in the first slot or occasion. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a first device, comprising:
having or obtaining configuration of a set of sidelink resource pools within one Bandwidth Part (BWP) for sidelink or in one carrier or cell for sidelink, wherein the set of sidelink resource pools comprise a first sidelink resource pool and/or a second sidelink resource pool;
not performing monitoring or not performing sensing within a first frequency region in a first slot or occasion;
performing monitoring or sensing in a second frequency region in the first slot or occasion, wherein the first frequency region and the second frequency region are within the first sidelink resource pool;
triggering or requesting sensing-based resource (re-)selection, in a second slot or occasion, for determining sidelink resources in the first sidelink resource pool;
determining a first set of slots or occasions based on the first slot or occasion and a set of periodicities, wherein the first slot or occasion is within a sensing window or duration associated with the sensing-based resource (re-)selection;
excluding candidate sidelink resources within the first frequency region in the first set of slots or occasions, in response to non-monitoring or non-sensing in the first frequency region in the first slot or occasion; and
keeping candidate sidelink resources within the second frequency region in the first set of slots or occasions, in response to the non-monitoring or non-sensing in the first frequency region in the first slot or occasion.

2. The method of claim 1, further comprising:
keeping the candidate sidelink resources within the second frequency region in the first set of slots or occasions comprises the first device preventing from excluding the candidate sidelink resources within the second frequency region in the first set of slots or occasions, in response to the non-monitoring or non-sensing in the first frequency region in the first slot or occasion.

3. The method of claim 1, further comprising:
preventing from excluding candidate sidelink resources within the second sidelink resource pool, in response to the non-monitoring or non-sensing in the first frequency region in the first slot or occasion.

4. The method of claim 1, further comprising at least one of:
triggering or requesting another sensing-based resource (re-)selection, in a third slot or occasion, for determining sidelink resources in the second sidelink resource pool; and/or
determining a second set of slots or occasions based on the first slot or occasion and another set of periodicities, wherein the first slot or occasion is within another sensing window or duration associated with the another sensing-based resource (re-)selection; and/or
keeping candidate sidelink resources within the second sidelink resource pool in the second set of slots or occasions, in response to the non-monitoring or non-sensing in the first frequency region in the first slot or occasion; and/or
preventing excluding the candidate sidelink resources within the second sidelink resource pool in the second set of slots or occasions, in response to the non-monitoring or non-sensing in the first frequency region in the first slot or occasion.

5. The method of claim 1, wherein:
not performing the monitoring or not performing the sensing within the first frequency region in the first slot or occasion means or comprises the first device performing sidelink or uplink transmission within the first frequency region in the first slot or occasion.

6. The method of claim 1, further comprising at least one of:
wherein the first frequency region and the second frequency region are non-overlapped in frequency domain; and/or
wherein the first frequency region and the second frequency region are separated with at least a frequency gap in frequency domain; and/or
wherein a division or partition of the first frequency region and the second frequency region is (pre-)configured or determined based on configuration of the first sidelink resource pool.

7. The method of claim 1, further comprising at least one of:
wherein the first device performs first sidelink transmission in a first sidelink resource of the first sidelink resource pool in the first slot or occasion; and/or
wherein a division or partition of the first frequency region and the second frequency region is determined based on the first sidelink resource; and/or
wherein the first frequency region comprises the first sidelink resource; and/or
wherein the second frequency region is determined based on the first sidelink resource and a frequency gap; and/or
wherein the first frequency region and the second frequency region are separated with at least the frequency gap in frequency domain.

8. A method of a first device, comprising:
having or obtaining configuration of a set of sidelink resource pools within one Bandwidth Part (BWP) for sidelink or in one carrier or cell for sidelink, wherein the set of sidelink resource pools comprise a first sidelink resource pool and/or a second sidelink resource pool;
not performing monitoring or not performing sensing within a first frequency region in a first slot or occasion;
performing monitoring or sensing in a second frequency region in the first slot or occasion, wherein the first frequency region and the second frequency region are within the first sidelink resource pool;
triggering or requesting sensing-based resource (re-)selection, in a second slot or occasion, for determining sidelink resources in the first sidelink resource pool;
determining a first set of slots or occasions based on the first slot or occasion and a set of periodicities, wherein the first slot or occasion is within a sensing window or duration associated with the sensing-based resource (re-)selection; and
excluding candidate sidelink resources within the first sidelink resource pool in the first set of slots or occasions, in response to the non-monitoring or non-sensing in the first frequency region in the first slot or occasion.

9. The method of claim 8, further comprising:
preventing from excluding candidate sidelink resources within the second sidelink resource pool, in response to the non-monitoring or non-sensing in the first frequency region in the first slot or occasion.

10. The method of claim 8, further comprising at least one of:
triggering or requesting another sensing-based resource (re-)selection, in a third slot or occasion, for determining sidelink resources in the second sidelink resource pool; and/or
determining a second set of slots or occasions based on the first slot or occasion and another set of periodicities, wherein the first slot or occasion is within another sensing window or duration associated with the another sensing-based resource (re-)selection; and/or
keeping candidate sidelink resources within the second sidelink resource pool in the second set of slots or occasions, in response to the non-monitoring or non-sensing in the first frequency region in the first slot or occasion; and/or
preventing from excluding the candidate sidelink resources within the second sidelink resource pool in the second set of slots or occasions, in response to the non-monitoring or non-sensing in the first frequency

11. The method of claim 8, wherein:
not performing the monitoring or not performing the sensing within the first frequency region in the first slot or occasion means or comprises the first device performing sidelink or uplink transmission within the first frequency region in the first slot or occasion.

12. The method of claim 8, further comprising at least one of:
wherein the first frequency region and the second frequency region are non-overlapped in frequency domain; and/or
wherein the first frequency region and the second frequency region are separated with at least a frequency gap in frequency domain; and/or
wherein a division or partition of the first frequency region and the second frequency region is (pre-)configured or determined based on configuration of the first sidelink resource pool.

13. The method of claim 8, further comprising at least one of:
wherein the first device performs a first sidelink transmission in a first sidelink resource of the first sidelink resource pool in the first slot or occasion; and/or
wherein a division or partition of the first frequency region and the second frequency region is determined based on the first sidelink resource; and/or
wherein the first frequency region comprises the first sidelink resource; and/or
wherein the second frequency region is determined based on the first sidelink resource and a frequency gap; and/or
wherein the first frequency region and the second frequency region are separated with at least the frequency gap in frequency domain.

14. A method of a first device, comprising:
having or obtaining configuration of a set of sidelink resource pools within one Bandwidth Part (BWP) for sidelink or in one carrier or cell for sidelink, wherein the set of sidelink resource pools comprise a first sidelink resource pool and a second sidelink resource pool;
performing a first sidelink transmission in the first sidelink resource pool in a first slot or occasion;
performing sidelink reception or monitoring in the second sidelink resource pool in the first slot or occasion;
triggering or requesting sensing-based resource (re-)selection, in a second slot or occasion, for determining sidelink resources in the first sidelink resource pool;
determining a first set of slots or occasions based on the first slot or occasion and a set of periodicities, wherein the first slot or occasion is within a sensing window or duration associated with the sensing-based resource (re-)selection; and
excluding candidate sidelink resources within the first sidelink resource pool in the first set of slots or occasions, in response to non-monitoring or non-sensing in the first sidelink resource pool in the first slot or occasion.

15. The method of claim 14, further comprising at least one of:
not performing monitoring or not performing sensing within the first sidelink resource pool in the first slot or occasion; and/or
being restricted or allowed to perform either:
(a) sidelink transmission, or
(b) sidelink reception or monitoring or sensing in one sidelink resource pool at a timing.

16. The method of claim 14, further comprising:
preventing from excluding candidate sidelink resources within the second sidelink resource pool, in response to the non-monitoring or non-sensing in the first sidelink resource pool in the first slot or occasion.

17. The method of claim 14, further comprising at least one of:
triggering or requesting another sensing-based resource (re-)selection, in a third slot or occasion, for determining sidelink resources in the second sidelink resource pool; and/or
determining a second set of slots or occasions based on the first slot or occasion and another set of periodicities, wherein the first slot or occasion is within another sensing window or duration associated with the another sensing-based resource (re-)selection; and/or
keeping candidate sidelink resources within the second sidelink resource pool in the second set of slots or occasions, in response to the non-monitoring or non-sensing in the first sidelink resource pool in the first slot or occasion; and/or
preventing from excluding the candidate sidelink resources within the second sidelink resource pool in the second set of slots or occasions, in response to the non-monitoring or non-sensing in the first sidelink resource pool in the first slot or occasion.
